(19) United States
(12) Patent Application Publication
(10) Pub. No.: US 2017/0145731 A1
(43) Pub. Date: May 25, 2017

(54) Door Assembly With Divided Screens

(71) Applicant: Carolina Hardware Distributors, LLC, Raleigh, NC (US)

(72) Inventor: Brandon Lee Bolick, Raleigh, NC (US)

(21) Appl. No.: 14/950,547

(22) Filed: Nov. 24, 2015

(51) Int. Cl. E06B 3/26; E06B 7/02; E06B 3/36; E06B 9/52

(52) U.S. Cl. CPC E06B 3/2605; E06B 9/52; E06B 7/02; E06B 3/36; E06B 2009/527

(57) ABSTRACT

A door assembly includes a subdoor. The subdoor is selectively openable by pivoting relative to the main door and includes a window panel (typically glass). An array of screens is disposed in front of the subdoor and includes a plurality of relatively smaller screens that are physically separated from each other by a lattice. The structure of the door allows for greater ease of assembly while providing an appearance of having “true divided lights.” Related methods are also discussed.

### BACKGROUND

The present invention relates to door assemblies, and particularly to door assemblies that have one or more windows and with a screen.

Numerous door assemblies are known in the art, and many of such door assemblies include a window to allow light to pass through the door. In addition, many of such door mounted windows are designed to be opened when desired. However, when the window is open, insects can also pass through the window opening unless there is a suitable screen to prevent their passage. As such, many doors with openable windows include screens. Unfortunately, the presence of the screen may have undesirable effects on the aesthetic appearance of the door, particularly when the window has been subdivided as in a so-called “true divided light” configuration. In a true divided light arrangement, a plurality of smaller window panes are arranged in an array approximately adjacent to each other in a common plane, but separated from each other by an intervening lattice (or “muntin”). The presence of a large screen in front of the lattice masks some of the aesthetic appeal of true divided light windows, but the presence of the screen is required for prevention of insect entry. In such a situation, aesthetics are typically trumped by functionality and/or cost, and a single large screen is used.

Thus, while the prior art door configurations may be suitable for some situations, they may not be ideal for all situations. Accordingly, there remains a need for alternative door assemblies, particularly door assemblies with a selectively openable window and a protective screen.

### SUMMARY

Described below are one or more embodiments of a door assembly that includes a subdoor. The subdoor is selectively openable by pivoting relative to the main door and includes a window panel (typically glass). An array of screens is disposed in front of the subdoor and includes a plurality of relatively smaller screens that are physically separated from each other by a lattice. The structure of the door allows for greater ease of assembly while providing an appearance of having “true divided lights.”

In one or more embodiments, the present invention provides a door assembly having a door frame and a first main door assembly, with the first main door assembly having a first main door, a first subdoor, a first lattice, and a plurality of first screens. The first main door assembly is pivotally mounted to the door frame for swinging movement relative thereto. The first main door has a first opening. The first subdoor has a first window panel and is pivotally mounted to the first main door for swinging movement relative thereto, about a first pivot axis, between a closed position and an open position. In the closed position, the first subdoor is disposed in the first opening and blocks off the first opening. In the open position, the first subdoor is positioned relative to the first main door such that the first subdoor is at least partially outside the first opening and the first opening is at most partially blocked by the first subdoor. The first subdoor has a free edge disposed opposite the first pivot axis, and the free edge is located more rearwardly in the open position than in the closed position. The first lattice is disposed in the first opening and in front of the first subdoor. The first lattice has a plurality of first lattice openings. The first screens are disposed in corresponding first lattice openings in the first lattice, such that the first lattice physically separates adjacent first screens from each other. The first window panel is larger in area than a largest one of the plurality of first screens.

The plurality of first screens may lie in a common plane, with the common plane parallel to, but disposed forward of, the first window panel. The first window panel may be formed of glass and/or may be tinted. The plurality of first screens may be generally geometrically identical. The lattice openings may be arranged in a regular array. The door assembly may further comprise weather stripping disposed between the first subdoor and the first main door when the first subdoor is in the closed position. The door assembly may further comprise a lock assembly operative to selectively lock the first subdoor in the closed position. The door assembly may comprise a second main door assembly similar to the first main door assembly.

In one or more embodiments, the present invention provides a door assembly having a door frame and a first main door assembly, with the first main door assembly having a first main door, a first subdoor, a first lattice, and a plurality of first screens. The first main door assembly is pivotally mounted to the door frame for swinging movement relative thereto. The first main door has a first opening and a first air channel through the first opening. The first subdoor has a first window panel and is pivotally mounted to the first main door for swinging movement relative thereto between a closed position and an open position. In the closed position, the first subdoor is disposed in the first opening and blocks off the first air channel. In the open position, a free edge of the first subdoor is positioned rearward relative to the first main door such that the first air channel through the opening is open. The first lattice is disposed in the first opening and in front of the first subdoor. The first lattice has a plurality of first lattice openings. The plurality of first screens are disposed in corresponding first lattice openings in the first lattice, with the first lattice physically separating adjacent first screens from each other. The first window panel is larger in area than a largest one of the plurality of first screens.

The plurality of first screens may lie in a common plane, with the common plane parallel to, but disposed forward of, the first window panel. The first window panel may be formed of glass and/or may be tinted. The plurality of first screens may be generally geometrically identical. The lattice openings may be arranged in a regular array. The door assembly may further comprise weather stripping disposed between the first subdoor and the first main door when the first subdoor is in the closed position. The door assembly may further comprise a lock assembly operative to selectively lock the first subdoor in the closed position. The door assembly may comprise a second main door assembly similar to the first main door assembly.

In some embodiments, the present invention provides a method of operating a door assembly. The method comprises pivoting open a subdoor rearward relative to a main door while the main door remains closed relative to a fixedly mounted door frame; the subdoor having a first window panel mounted therein. The opening of the subdoor results in the opening of an air channel through a first opening in the main door while a plurality of first screens are disposed in the first opening of the main door and forwardly of the subdoor. The door assembly is such that the plurality of first screens are disposed in a lattice, with the lattice physically separates adjacent first screens from each other, and the first window panel is larger in area than a largest one of the plurality of first screens. The method may further comprise thereafter pivoting the subdoor forward relative to the main door to a closed position while the main door remains closed relative to the door frame, wherein the closing of the subdoor closes the air channel through the first opening of the main door.

The various aspects of the devices and methods discussed herein may be used alone or in any combination. Further, the present invention is not limited to the above features and advantages. Indeed, those skilled in the art will recognize additional features and advantages upon reading the following detailed description, and upon viewing the accompanying drawings.

### BRIEF DESCRIPTION OF THE DRAWINGS

FIG. 1 shows a door assembly according to one embodiment, mounted in a building wall.

FIG. 2 shows a rear view of the door assembly of FIG. 1, with the subdoor in a closed position.

FIG. 3 shows a rear view of the door assembly of FIG. 1, with the subdoor in an open position.

FIG. 4 shows a side cross-sectional view of the door of FIG. 2 with the frame removed for clarity.

FIG. 5 shows a detail view of a portion of the cross-section of FIG. 4.

FIG. 6 shows a side cross-sectional view of the door of FIG. 3.

### DETAILED DESCRIPTION

In one or more embodiments, the present application is directed to a door assembly that includes a subdoor. The subdoor is selectively openable by pivoting relative to the main door and includes a window panel (typically glass). An array of screens is disposed in front of the subdoor and includes a plurality of relatively smaller screens that are physically separated from each other by a lattice. The structure of the door allows for greater ease of assembly while providing an appearance of having “true divided lights.”

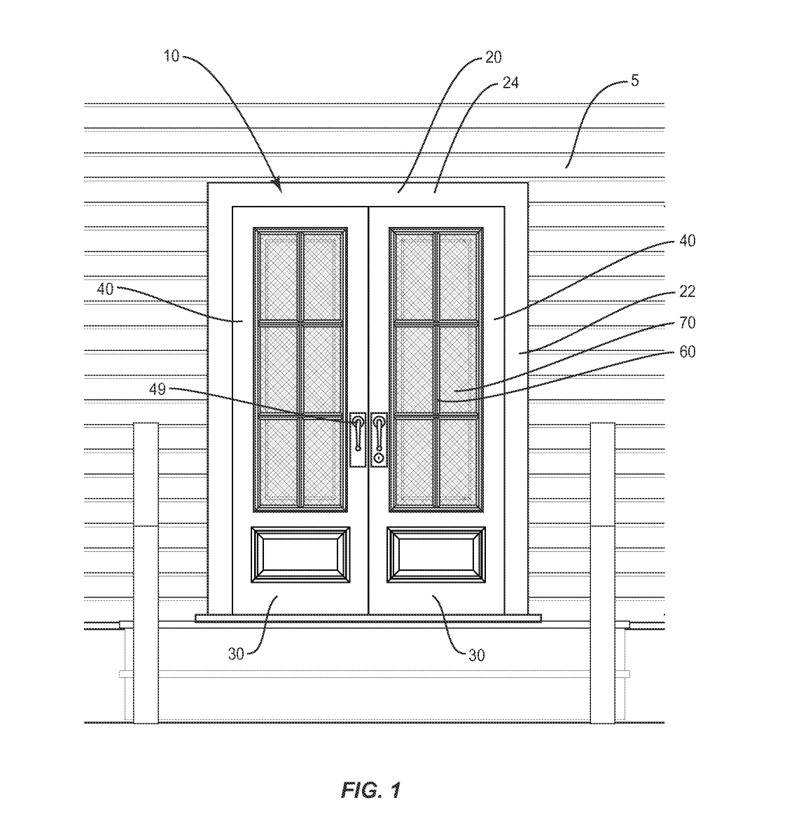

The door assembly, generally indicated at 10, is intended to be mounted in a “door” opening in a wall of a building 5, such as a residential home shown in FIG. 1, but may alternatively be mounted for display, such as in a showroom. For illustrative purposes, the door assembly 10 will be discussed below generally in the context of a “double” door arrangement mounted to a residential door opening, but it should be understood that the door assembly 10 may alternatively be a “single” door, or be part of a “French” door arrangement, or have more than two main doors.

The door assembly 10 of FIG. 1 includes a frame 20 and two main door assemblies 30. The frame 20 helps mount the main door assemblies 30 to the corresponding building wall, and may take any suitable form known in the industry. Typically, the frame 20 includes a plurality of vertical members 22 and a plurality of horizontal members 24, including associated trim pieces.

Each main door assembly 30 includes a main door 40, a subdoor 50, a lattice 60, and a plurality of screens 70. The screens 70 are mounted to the lattice 60 and disposed forward of the subdoor 50. The subdoor 50 is selectively openable, so that air may be allowed to pass through the screen 70 and opening of the main door assembly 30 without having to open the main door 40. The two main door assemblies are advantageously generally mirror images of each other, but optionally with slight differences related to differing door hardware (e.g., handle and strike plate) and related structures (e.g., lock pin recesses, astragal(s)). For simplicity, the following discussion will focus on the right main door assembly 30, with it being understood that the left main door assembly 30 is substantially similar.

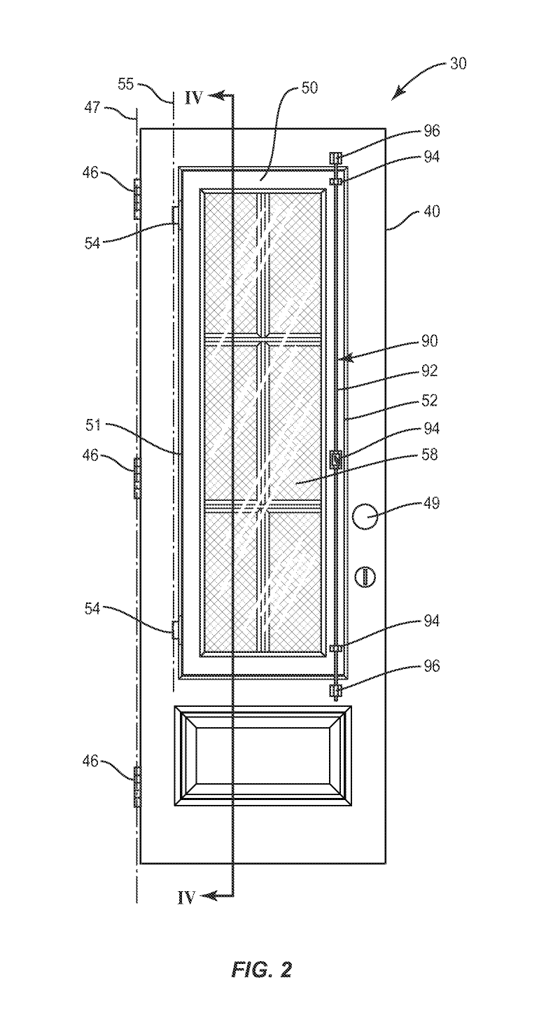

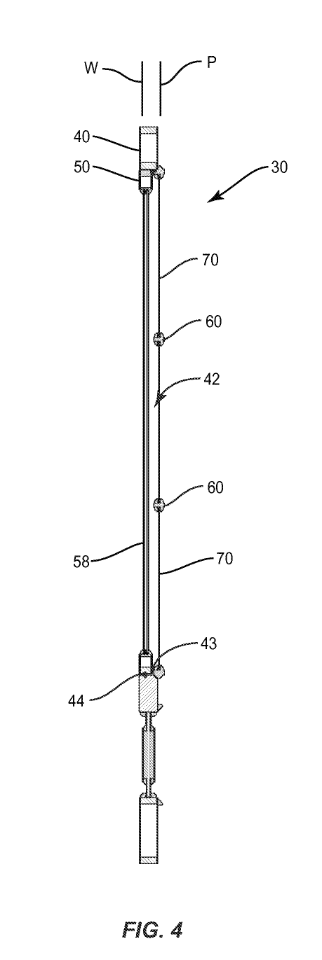

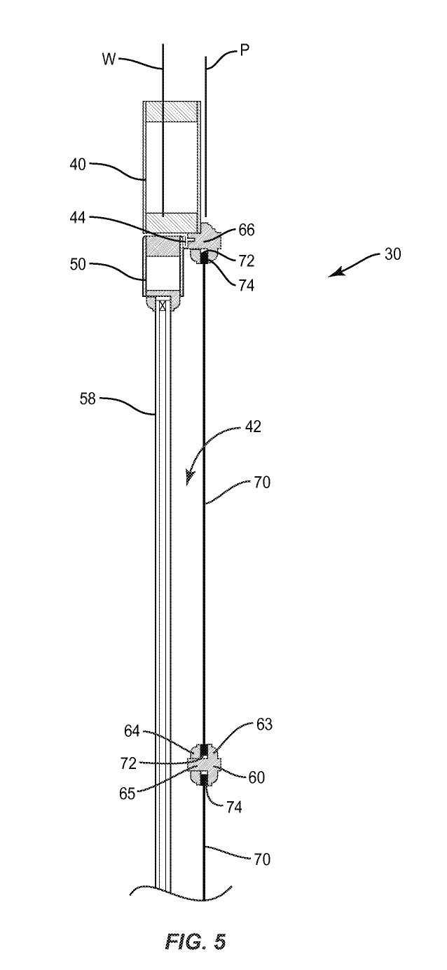

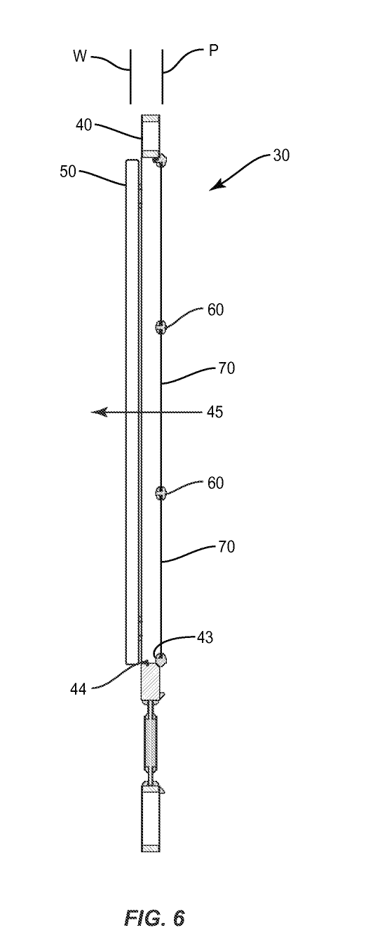

Referring to FIGS. 2-6, the right main door assembly 30 includes a main door 40, a subdoor 50, a lattice 60, and a plurality of screens 70. The main door 40 may take any suitable form, such as the generally rectangular shape shown in FIG. 2. The main door 40 includes an opening 42 therethrough, which accepts subdoor 50 as discussed further below. The main door 40 is pivotally mounted to the frame 20 by suitable hinges 46 so that the user may swing the main door 40 open and closed about a generally vertical hinge axis 47. The main body of the main door 40 may be solid in construction or may, as illustrated, be formed of panels with suitable insulation disposed therebetween.

Subdoor 50 is mounted to main door 40 for pivoting movement relative thereto. The subdoor 50 advantageously has a generally rectangular shape, similar to main door 40, but other shapes may alternatively be used. The subdoor 50 is mounted to main door 40 via corresponding hinges 54, so that the user may swing subdoor 50 relative to main door 40 about pivot axis 55. Note that pivot axis 55 is advantageously parallel to hinge axis 47. For ease of reference, the edge of subdoor 50 nearer to pivot axis 55 is referred to as the mounted edge 51, while the opposite edge of the subdoor 50 is referred to as the free edge 52. Between the mounted edge 51 and the free edge 52, the subdoor 50 includes an opening having a window panel 58 mounted therein. This window panel 58 may be formed from any suitable material such as glass or plastic, and is advantageously transparent or at least translucent, and may be tinted as desired. In preferred embodiments, the window panel 58 is substantially flat and planar, so as to lie in a plane W that is vertical and parallel to the subdoor 50, but this is not required in all embodiments. The main body of the subdoor 50 may be solid in construction or may, as illustrated, be formed of panels with suitable insulation disposed therebetween.

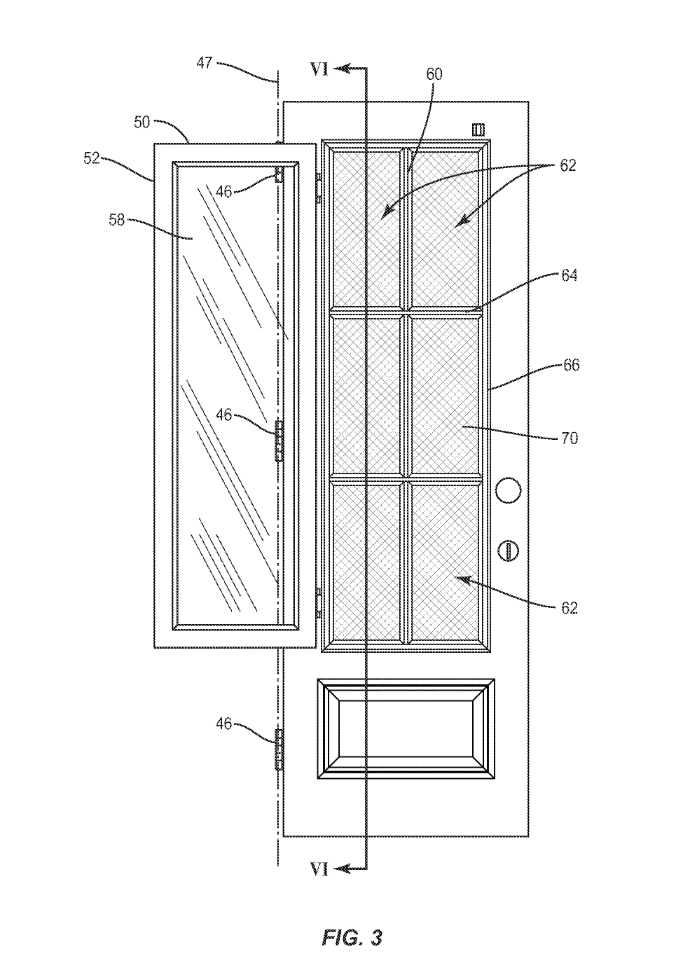

The subdoor 50 may be moved between a closed position (FIG. 2) and an open position (FIG. 3). In the open position, free edge 52 of subdoor 50 is disposed rearward of the opening 42 in main door 40. Thus, the subdoor 50 is at least partially outside the opening 42 of main door 40. In the closed position, free edge 52 of the subdoor 50 is disposed in opening 42, and subdoor 50 blocks off opening 42 such that air does move through opening 42. Note that while subdoor 50 may abut against any portion of main door 40 in the closed position, subdoor 50 advantageously abuts against weather stripping 44 so that a good seal is achieved. In contrast, when subdoor 50 is in the open position, opening 42 is at most partially blocked by subdoor 50, and advantageous substantially unblocked by subdoor 50 (when subdoor 50 is fully opened). Thus, with subdoor 50 in the open position, an air channel 45 through opening 42 is open, while with subdoor 50 in the closed position, air channel 45 is blocked by subdoor 50.

A lock assembly 90 may optionally be employed to enable the subdoor 50 to be selectively locked in the closed position. Such a lock assembly 90 may take any form known in the industry, such as the slide bolt 92, brackets 94, and catch 96 shown in FIG. 2.

A lattice 60 is mounted to the main door 40 and disposed in the opening 42. The lattice 60 has a front face 63 facing away from the subdoor 50, and a rear face 64 facing toward the subdoor 50. The front face 63 and rear face 64 are interconnected by suitable interconnecting rib(s) 65, which may, in some embodiments, be integrated into the front face 63 or the rear face 64, as is desired. The lattice 60 may optionally include a peripheral bezel 66 to facilitate mounting to the main door 40 and/or for aesthetic purposes. The lattice 60 functionally divides the opening 42 into a plurality of smaller openings, sometimes referred to herein as screen openings 62. As such, the lattice 60 functions as a muntin structure relative to the screens 70 in the screen openings (see discussion below). There may be two or more screen openings 62, with about six screen openings 62 believed to be advantageous from an aesthetic perspective. A rear portion of the lattice 60 advantageously forms a rearwardly facing lip 43 around opening 42 in main door 40. Suitable weather stripping 44 may be mounted against this lip 43, and/or at other locations, to help provide a seal between the main door 40 and the subdoor 50 when the subdoor 50 is closed.

A plurality of screens 70 are mounted to the lattice 60, with each screen 70 disposed in a corresponding screen opening 62. Each screen 70 has a peripheral border 72 that is mounted in the lattice 60. As such, the peripheral border 72 of each screen 70 is not visible because it is hidden by the front face 63 and rear face 64 of the lattice 60. Advantageously, the peripheral border 72 of each screen 70 is adjacent to, and may abut against, the corresponding interconnecting rib(s) 65 that border the corresponding screen opening 62. In some embodiments, each screen 70 may advantageously have an outer support frame 74 for increased ease of handling of the screen 70, with the outermost portion of the support frame 74 or the screen material (whichever is disposed farther laterally outward) defining the peripheral border 72. Thus, the outer support frame 74, if present, is considered part of the screen 70 for purposes of identifying the peripheral border 72. Note that each screen 70 is smaller in size than the window panel 58 of the subdoor 50. That is, the area of each screen 70 is smaller than the area of window panel 58. Note also that the plurality of screens 70 may lie in a common screen plane P, which is disposed forward of the plane P of window panel 58.

As indicated above, the two main door assemblies 30 are advantageously generally mirror images of each other, but optionally with slight differences related to differing door hardware (e.g., handle 49 and strike plate) and related structures (e.g., lock pin recesses, astragal(s)). Thus, in one example, the right main door assembly 30 may include a handle mechanism 49 (advantageously with locking functionality) and an astragal for visually bridging a gap between the right main door assembly 30 and the left main door assembly 30. And, the left main door assembly 30 may include a lock pin recess in the medial lateral edge of the main door 40 and optionally one or more slide bolt units (not shown) for selectively locking the main door 40 in a closed position. As can be appreciated, any or all of these left/right relationships may be reversed as is desired.

The door assembly 10 may be made of any suitable materials known in the art. Merely by way of example, the frame 20, main door 40, and subdoor 50 may be made from wood or a wood composite with insulation, the window panel 58 made from glass, the lattice 60 made from wood, and the screen 70 from suitable metal mesh. Of course, other materials known in the door industry may alternatively be used.

Manufacture of the door assembly 30 may use typical door manufacturing techniques. Of particular note is that each main door assembly 30 of the illustrative embodiment requires only a single larger window panel 58 (e.g., glass), rather than multiple smaller pieces, and multiple smaller screens 70 rather than a single larger screen, yet the door assembly 10 is able to provide a “true divided light” appearance. Thus, various door assemblies 10 may be made with different types of glass, with a reduced glass inventory burden. And, the screen material may readily cut to size, with screen material being relatively easier to cut to size than glass. In addition, the smaller size of the screens 70, with or without a support frame 74, facilitates handling of the screens 70, such as for removal and repair/replacement of a damaged screen 70.

It should be noted that the screens 70 may be mounted to the lattice 60 by any suitable method. In one approach, the front face 63 of the lattice 60 is arranged on a work surface and the interconnecting rib(s) 65 are either preconfigured with the front face 63, or added to the front face 63. Then the plurality of screens 70 are inserted into their respective locations and the rear face 64 added to sandwich the screens 70 between the front face 63 and rear face 64 of lattice 60.

The discussion above has generally been in the context of a double door arrangement with two main door assemblies 30. However, such a configuration is not required in all embodiments. Indeed, the present inventive concept may be readily applied to a so-called single door, with a single main door assembly 30. Likewise, the inventive concept may be applied to other door configurations with more than two main door assemblies 30, although such configurations may be rather cumbersome to handle during installation. And, regardless of the number of main door assemblies 30, the outer profile of the main door 40 and subdoor 50, and their aesthetic attributes may take any form known in the door art.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

What is claimed is:

1. A door assembly, comprising:
a door frame;
a first main door assembly pivotally mounted to the door frame for swinging movement relative thereto;
the first main door assembly comprising:
a first main door having a first opening;
a first subdoor having a first window panel; the first subdoor pivotally mounted to the first main door for swinging movement relative thereto, about a first pivot axis, between a closed position and an open position; wherein, in the closed position, the first subdoor is disposed in the first opening and blocks off the first opening; wherein in the open position, the first subdoor is positioned relative to the first main door such that the first subdoor is at least partially outside the first opening and the first opening is at most partially blocked by the first subdoor;
wherein the first subdoor has a free edge disposed opposite the first pivot axis; wherein the free edge is located more rearwardly in the open position than in the closed position;
a first lattice disposed in the first opening and in front of the first subdoor; the first lattice having a plurality of first lattice openings;
a plurality of first screens disposed in corresponding first lattice openings in the first lattice; wherein the first lattice physically separates adjacent first screens from each other;
wherein the first window panel is larger in area than a largest one of the plurality of first screens.

2. The door assembly of claim 1, wherein the plurality of first screens lie in a common plane; wherein the common plane is parallel to, but disposed forward of, the first window panel.

3. The door assembly of claim 1, wherein the first window panel is formed of glass.

4. The door assembly of claim 3, wherein the first window panel is formed of tinted glass.

5. The door assembly of claim 1, wherein the plurality of first screens are generally geometrically identical.

6. The door assembly of claim 1, further comprising a lock assembly operative to selectively lock the first subdoor in the closed position.

7. The door assembly of claim 1, wherein the lattice openings are arranged in a regular array.

8. The door assembly of claim 1, further comprising weather stripping disposed between the first subdoor and the first main door when the first subdoor is in the closed position.

9. The door assembly of claim 1, further comprising a second main door assembly pivotally mounted to the door frame for swinging movement relative thereto, the second main door assembly comprising:
a second main door pivotally mounted to the door frame for swinging movement relative thereto; the second main door having a second opening;
a second subdoor having a second window panel; the second subdoor pivotally mounted to the second main door for swinging movement relative thereto, about a second pivot axis, between a closed position and an open position; wherein, in the closed position, the second subdoor is disposed in the second opening and blocks off the second opening; wherein in the open position, the second subdoor is positioned relative to the second main door such that the second subdoor is at least partially outside the second opening and the second opening is at most partially blocked by the second subdoor;
wherein the second subdoor has a free edge disposed opposite the second pivot axis; wherein the free edge is located more rearwardly in the open position than in the closed position;
a second lattice disposed in the second opening and in front of the second subdoor; the second lattice having a plurality of second lattice openings;
a plurality of second screens disposed in corresponding second lattice openings in the second lattice; wherein the second lattice physically separates adjacent second screens from each other;
wherein the second window panel is larger in area than a largest one of the plurality of second screens.

10. A door assembly, comprising:
a door frame;
a first main door assembly pivotally mounted to the door frame for swinging movement relative thereto;
the first main door assembly comprising:
a first main door having a first opening and a first air channel through the first opening;
a first subdoor having a first window panel; the first subdoor pivotally mounted to the first main door for swinging movement relative thereto between a closed position and an open position; wherein, in the closed position, the first subdoor is disposed in the first opening and blocks off the first air channel; wherein in the open position, a free edge of the first subdoor is positioned rearward relative to the first main door such that the first air channel through the opening is open;
a first lattice disposed in the first opening and in front of the first subdoor; the first lattice having a plurality of first lattice openings;
a plurality of first screens disposed in corresponding first lattice openings in the first lattice; wherein the first lattice physically separates adjacent first screens from each other;
wherein the first window panel is larger in area than a largest one of the plurality of first screens.

11. The door assembly of claim 10, wherein the plurality of first screens lie in a common plane; wherein the common plane is parallel to, but disposed forward of, the first window panel.

12. The door assembly of claim 10, wherein the first window panel is formed of glass.

13. The door assembly of claim 12, wherein the first window panel is formed of tinted glass.

14. The door assembly of claim 10, wherein the plurality of first screens are generally geometrically identical.

15. The door assembly of claim 10, further comprising a lock assembly operative to selectively lock the first subdoor in the closed position.

16. The door assembly of claim 10, wherein the lattice openings are arranged in a regular array.

17. The door assembly of claim 10, further comprising weather stripping disposed between the first subdoor and the first main door when the first subdoor is in the closed position.

18. The door assembly of claim 10, further comprising a second main door assembly pivotally mounted to the door frame for swinging movement relative thereto, the second main door assembly comprising:
a second main door having a second opening and a second air channel through the second opening;
a second subdoor having a second window panel; the second subdoor pivotally mounted to the second main door for swinging movement relative thereto between a closed position and an open position; wherein, in the closed position, the second subdoor is disposed in the second opening and blocks off the second air channel; wherein in the open position, a free edge of the second subdoor is positioned rearward relative to the second main door such that the second air channel through the opening is open;
a second lattice disposed in the second opening and in front of the second subdoor; the second lattice having a plurality of second lattice openings;
a plurality of second screens disposed in corresponding second lattice openings in the second lattice; wherein the second lattice physically separates adjacent second screens from each other;
wherein the second window panel is larger in area than a largest one of the plurality of second screens.

19. A method of operating a door assembly, the method comprising:
pivoting open a subdoor rearward relative to a main door while the main door remains closed relative to a fixedly mounted door frame; the subdoor having a first window panel mounted therein;
the opening of the subdoor resulting in the opening of an air channel through a first opening in the main door while a plurality of first screens are disposed in the first opening of the main door and forwardly of the subdoor;
wherein the plurality of first screens are disposed in a lattice, with the lattice physically separates adjacent first screens from each other;
wherein the first window panel is larger in area than a largest one of the plurality of first screens.

20. The method of claim 19, further comprising thereafter pivoting the subdoor forward relative to the main door to a closed position while the main door remains closed relative to the door frame, wherein the closing of the subdoor closes the air channel through the first opening of the main door.
